(19) United States
(12) Patent Application Publication
(10) Pub. No.: US 2015/0142604 A1
(43) Pub. Date: May 21, 2015

(54) CODES WITH USER PREFERENCES

(71) Applicant: Benjamin Kneen, Boston, MA (US)

(72) Inventor: Benjamin Kneen, Boston, MA (US)

(21) Appl. No.: 14/083,388

(22) Filed: Nov. 18, 2013

(51) Int. Cl. G06Q 30/06

(52) U.S. Cl. CPC G06Q 30/0613
USPC 705/26.41

(57) ABSTRACT

Systems and methods for facilitating payment at checkout are described. A service provider collects and stores user preference information in advance of checkout. When the user is ready to pay, a code containing the user preferences is generated and presented to a merchant during checkout. User preferences can be matched to a merchant data request once the merchant is identified. Specific user preferences for specific merchants can also be stored and retrieved.

### BACKGROUND

1. Field of the Invention

The present invention generally relates to facilitating quick and convenient checkout for a consumer using a code.

2. Related Art

More and more consumers are purchasing items and services over electronic networks such as, for example, the Internet. Consumers routinely purchase products and services from merchants and individuals alike. The transactions may take place directly between a conventional or on-line merchant or retailer and the consumer, and payment is typically made by entering credit card or other financial information. Transactions may also take place with the aid of an online or mobile payment service provider such as, for example, PayPal, Inc. of San Jose, Calif. Such payment service providers can make transactions easier and safer for the parties involved. Purchasing with the assistance of a payment service provider from the convenience of virtually anywhere using a mobile device is one main reason why online and mobile purchases are growing very quickly.

Increasingly, consumers are bombarded with questions at the checkout counter. May I start with your phone number? What's your ZIP Code? Are you a member of our rewards program? Do you need batteries? Any coupons? Would you like a book of stamps? Would you be interested in donating to this charity? Would you like to save 10 percent today by applying for our credit card? Paper or plastic? Consumers frequently find these questions annoying and intrusive. Thus, a need exists for systems and methods that improve the consumer experience at checkout.

### BRIEF DESCRIPTION OF THE FIGURES

FIG. 1 is a is a block diagram of a networked system suitable for implementing the methods described herein according to an embodiment of the present disclosure;

FIG. 2 is a flowchart showing a method for facilitating payments at checkout according to an embodiment of the present disclosure; and

FIG. 3 is a block diagram of a computer system suitable for implementing one or more components in FIG. 1 according to one embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure provides systems and methods for making the consumer experience quicker and more enjoyable during checkout. A service provider collects user preference information from a user in advance, stores the preference information for that user in a database, and generates a code containing the user preferences. User preferences can include whether or not the user wants an electronic receipt, wants a paper or plastic bag, wants to make a charity donation, wants to buy stamps, etc. When the user is ready to pay, the code is displayed on a user mobile device and presented to a merchant during checkout. The user preferences are retrieved at will by the service provider. In some embodiments, the code contains payment information (e.g., funding sources, membership cards, rewards programs, etc.) to assist the user in paying for his or her purchase. Incorporating user preferences into a code decreases the delay caused by questions asked at checkout. In addition, the code increases the accuracy in information capture for the merchant, and can increase participation rates by users to provide certain information. Moreover, combining payment information into a code reduces the inconvenience caused by carrying numerous cards.

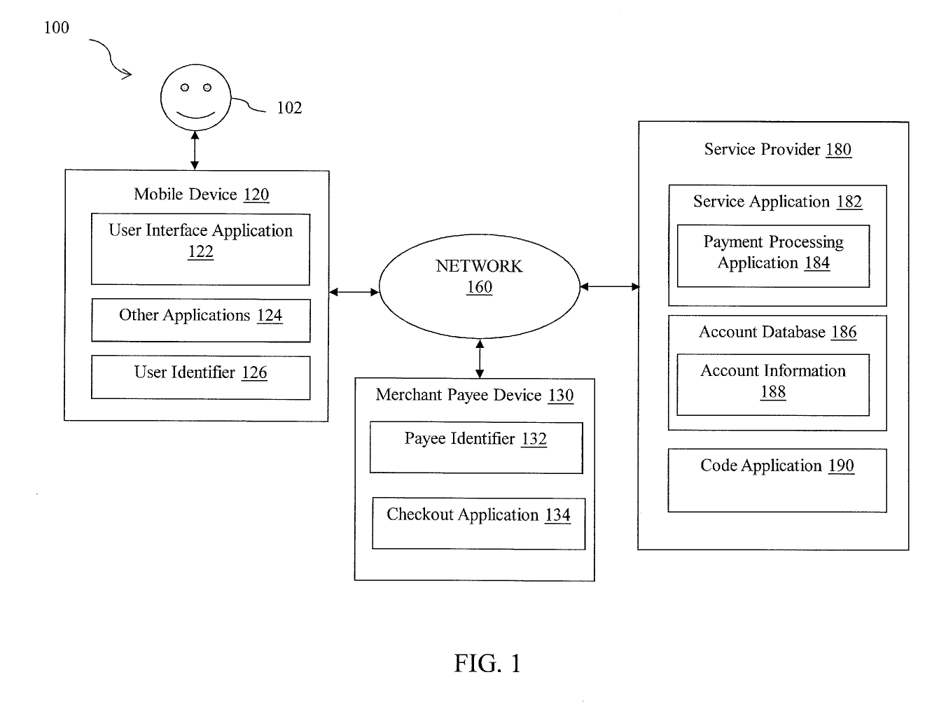

FIG. 1 illustrates an exemplary embodiment of a network-based system 100 for implementing one or more processes described herein over a network 160. As shown, network-based system 100 may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities. As shown in FIG. 1, the system 100 includes at least one mobile device 120, at least one merchant payee device 130, and at least one service provider server 180 in communication over the network 160.

The network 160, in one embodiment, may be implemented as a single network or a combination of multiple networks. For example, in various embodiments, the network 160 may include the Internet and/or one or more intranets, landline networks, wireless networks, and/or other appropriate types of communication networks. In another example, the network may comprise a wireless telecommunications network (e.g., mobile cellular phone network) adapted to communicate with other communication networks, such as the Internet.

The mobile device 120, in various embodiments, may be implemented using any appropriate combination of hardware and/or software configured for wired and/or wireless communication over the network 160. In various examples, mobile device 120 may be implemented as a wireless telephone (e.g., cellular or mobile phone), a tablet, a personal digital assistant (PDA), a tablet computer, and/or various other generally known types of wired and/or wireless computing devices. It should be appreciated that mobile device 120 may be referred to as a user device or a customer device without departing from the scope of the present disclosure.

The mobile device 120, in one embodiment, may be utilized by the user 102 to interact with the service provider server 180, over the network 160. For example, the user 102 may log in to a mobile application run by the service provider via the mobile device 120.

In various implementations, a user profile may be created using data and information obtained from cellular phone activity over the network 160. Cellular phone activity transactions may be used by the service provider server 180 to create at least one user profile for the user 102 based on activity from the mobile device 120. The user profile may be updated with each financial and/or information transaction (e.g., payment transaction, purchase transaction, etc.) achieved through use of the mobile device 120. In various aspects, this may include the type of transaction and/or the location information from the mobile device 120. As such, the profile may be used for recognizing patterns of potential fraud, setting transaction limits on the user, etc.

The mobile device 120, in one embodiment, includes a user interface application 122, which may be utilized by the user 102 to conduct transactions (e.g., shopping, purchasing, bidding, transferring, etc.) with the service provider server 180 over the network 160. In one aspect, funds may be directly and/or automatically debited from an account related to the user 102 via the user interface application 122 and deposited into an account associated with a merchant.

In one implementation, the user interface application 122 comprises a software program, such as a text-based interface, executable by a processor that is configured to interface and communicate with the service provider server 180 via the network 160. In another implementation, the user interface application 122 comprises a browser module that provides a network interface to browse information available over the network 160. For example, the user interface application 122 may be implemented, in part, as a web browser to view information available over the network 160.

The mobile device 120, in various embodiments, may include other applications 124 as may be desired in one or more embodiments of the present disclosure to provide additional features available to user 102. In one example, such other applications 124 may include security applications for implementing client-side security features, programmatic client applications for interfacing with appropriate application programming interfaces (APIs) over the network 160, and/or various other types of generally known programs and/or software applications. In still other examples, the other applications 124 may interface with the user interface application 122 for improved efficiency and convenience.

The mobile device 120, in one embodiment, may include at least one user identifier 126, which may be implemented, for example, as operating system registry entries, cookies associated with the user interface application 122, identifiers associated with hardware of the mobile device 120, or various other appropriate identifiers. The user identifier 126 may include one or more attributes related to the user 102, such as personal information related to the user 102 (e.g., a personal identification number) and banking information and/or funding sources (e.g., one or more banking institutions, credit card issuers, user account numbers, security data and information, etc.). In various implementations, the user identifier 126 may be passed with a user login request to the service provider server 180 via the network 160, and the user identifier 126 may be used by the service provider server 180 to associate the user 102 with a particular user account maintained by the service provider server 180.

The mobile device 120, in one embodiment, includes a geo-location component adapted to monitor and provide an instant geographical location (i.e., geo-location) of the mobile device 120. In one implementation, the geo-location of the mobile device 120 may include global positioning system (GPS) coordinates, zip-code information, area-code information, street address information, and/or various other generally known types of geo-location information. In one example, the geo-location information may be directly entered into the mobile device 120 by the user 102 via a user input component, such as a keyboard, touch display, and/or voice recognition microphone. In another example, the geo-location information may be automatically obtained and/or provided by the mobile device 120 via an internal or external GPS monitoring component. In one aspect, when interfacing with the mobile device 120, the user 102 may elect to provide or may be prompted to provide permission for the release of geo-location information. Accordingly, the user 102 may have exclusive authority to allow transmission of geo-location information from the mobile device 120 to the service provider server 180. In any instance, the service provider server 180 may communicate with the mobile device 120 via the network 160 and request permission to acquire geo-location information from the mobile device 120 for geo-location based mobile commerce.

The merchant payee device 130, in various embodiments, may be implemented using any appropriate combination of hardware and/or software configured for wired and/or wireless communication over the network 160. In one embodiment, the merchant payee device 130 includes a point of sale (POS) terminal. The merchant payee device 130 may be maintained, for example, by a conventional or on-line merchant, conventional or digital goods seller, individual seller, and/or application developer offering various products and/or services in exchange for payment to be received conventionally or over the network 160.

The merchant payee device 130, in one embodiment, may be utilized by user 102 to interact with the service provider server 180 over the network 160. For example, user 102 may conduct financial transactions (e.g., payment of a merchant) with the service provider server 180 via the merchant payee device 130. The merchant payee device 130 may include one or more payee device identifiers 132, which may be implemented as operating system registry entries, identifiers associated with hardware of the merchant payee device 130, and/or various other appropriate identifiers. The payee device identifier 132 may include attributes related to the merchant payee device 130, such as identification information (e.g., merchant associated with the merchant payee device 130, a location address, Global Positioning System (GPS) coordinates, etc.).

In various implementations, the payee device identifier 132 may be passed with network traffic data and information to the service provider server 180, and the payee device identifier 132 may be used by the service provider server 180 to associate one or more network transactions of user 102 with one or more particular user financial accounts maintained by the service provider server 180.

The merchant payee device 130 also includes a checkout application 134 which may be configured to facilitate a purchase by user 102. The checkout application 134 may be configured to accept payment information from the user 102 through the mobile device 120, directly from the user 102, and/or from the service provider through service provider server 180 over the network 160.

The service provider server 180, in one embodiment, may be maintained by a transaction processing entity, which may provide processing for financial transactions and/or information transactions between the user 102 and merchant payee device 130. As such, the service provider server 180 includes a service application 182, which may be adapted to interact with the mobile device 120 over the network 160 to facilitate financial transactions. In one example, the service provider server 180 may be provided by PayPal®, Inc., eBay® of San Jose, Calif., USA, and/or one or more financial institutions or a respective intermediary that may provide multiple point of sale devices at various locations to facilitate transaction routings between merchants and, for example, financial institutions.

The service application 182, in one embodiment, utilizes a payment processing application 184 to process purchases and/or payments for financial transactions between the user 102 and a merchant. In one implementation, the payment processing module 184 assists with resolving financial transactions through validation, delivery, and settlement. As such, the service application 182 in conjunction with the payment processing application 184 settles indebtedness between the user 102 and a merchant, wherein accounts may be directly and/or automatically debited and/or credited of monetary funds in a manner as accepted by the banking industry.

The service provider server 180, in one embodiment, may be configured to maintain one or more user accounts and merchant accounts in an account database 186, each of which may include account information 188 associated with one or more individual users (e.g., user 102) and/or merchants. For example, account information 188 may include private financial information of a user and/or merchant, such as one or more account numbers, passwords, credit card information, banking information, user preference information, payment information (e.g., coupons, rewards, credits, etc.) or other types of financial information, which may be used to facilitate financial transactions between the user 102 and a merchant. It should be appreciated that the methods and systems described herein may be modified to accommodate users and merchants that may or may not be associated with at least one existing user account.

In some embodiments, service provider server 180 also includes a code application 190, which generates a code containing user information, e.g., user preferences and payment information. For example, the code application 190 receives an indication that the user 102 is ready to pay a merchant, retrieves user preference information from account database 188 for that merchant, and creates and displays the code. The code may then be presented to a merchant during checkout to eliminate the need for questioning by the cashier. The code includes the relevant user preferences for that particular merchant. For example, paper or plastic bag preferences are passed to a grocery store, but not a clothing store, and zip code information is passed to a national merchant, but not a regional merchant.

Advantageously, the present disclosure matches user preferences to relevant merchant data requests. In an embodiment, the service provider server 180 determines which merchant the user 102 wants to purchase an item from by, for example, determining user location, from user check-in, or other suitable methods. Once the merchant is identified, the service provider server 180 determines what user preferences are relevant for that specific merchant. In some embodiments, specific user preferences for specific merchants have already been stored and are retrieved by the service provider for the merchant payee device 130 via the network 160.

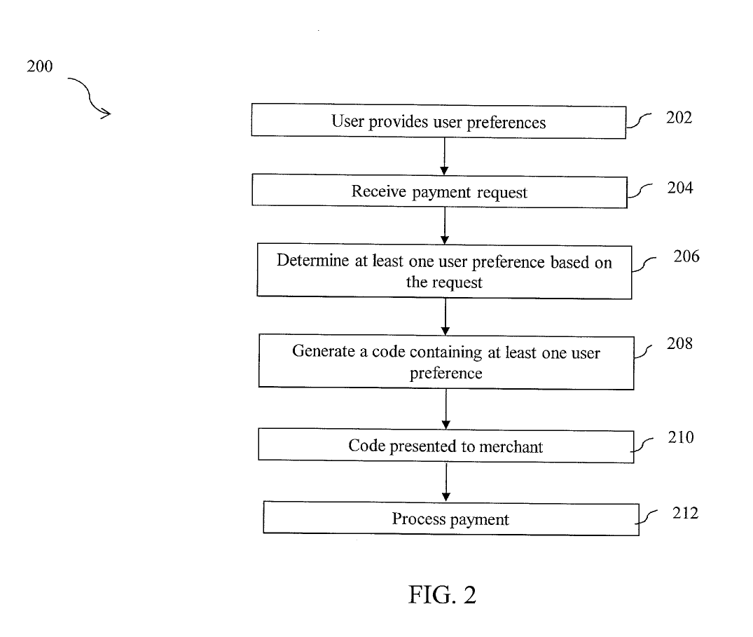

Referring now to FIG. 2, a method 200 of facilitating payments at checkout is illustrated according to an embodiment of a present disclosure. In the embodiment of the method 200 described below, a service provider provides user 102 with a user account, and the user 102 may use the user account to fund payments for purchases made to merchant payees. The service provider may be, for example, PayPal®, Inc. of San Jose, Calif., which assists in the making of payments from the user 102 to the merchant by transferring funds from the user account to a merchant account. However, these embodiments are meant to be merely exemplary, and one of skill in the art will recognize that a variety of modifications may be made to the payment system discussed herein without departing from the scope of the present disclosure.

In one embodiment, the user registers with a service provider, which runs the mobile application on the mobile device 120. Registration may include signing up for the service and agreeing to any terms required by the service provider, such as through mobile device 120. In one embodiment, the mobile device 120 is a smart phone, a PC, or a computing tablet. In other embodiments, registration may be done completely through the mobile device 120, partially through the mobile device 120, or without using the mobile device 120, such as through a phone call or in-person visit to a representative of the service provider.

The user 102 may be requested to provide specific information for registration, such as, but not limited to, a name, address, phone number, email address, picture, a user name for the account, and a password or PIN for the account. The type of information may depend on whether the user already has an account with the payment service provider. Requested information may be entered through the user device or other means, including voice or manual key entry. Once all the requested information is received and confirmed, the payment service provider may create an account for the user.

The method 200 begins at step 202, where the user 102 provides, and the service provider server 180 collects user information, including user preferences. User preferences may include packaging preferences, purchase preferences, personal information preferences, donation preferences, receipt preferences, etc. In some embodiments, the packaging preferences include a preference for plastic or paper shopping bags, the purchase preferences include a preference to purchase additional items (e.g., stamps, batteries, candy, etc.) at checkout, the personal information preferences comprises a preference to share contact (e.g., address, phone number, email address, etc.) or demographic (e.g., age, gender, income, etc.) information, the donation preferences include a preference to donate to a specific charity (e.g., Ronald McDonald House), and the receipt preferences include preferences regarding how the user wants to receive information (e.g., regular mail, email, phone, etc.). For instance, the user 102 may indicate that he or she does not want a paper receipt, but an electronic receipt, wants to receive advertisements and promotional material by email, but not by regular mail, wants paper bags instead of plastic, does not want to purchase any items such as batteries, candy, or stamps at checkout, does not want to provide a zip code, telephone number, or email address, and wants to donate to a charity, but only if it relates to cancer. The user 102 can provide preferences for a wide variety of subject matters.

In some embodiments, the preferences may be grouped according to a specific merchant (e.g., Best Buy, Target, Walgreens, McDonald's. Macy's, etc.), a merchant category (e.g., grocery store, restaurant, pharmacy, electronics store, gas station, etc.), and/or a merchant location (e.g., shopping center, zip code, city, state, etc.). For example, the user 102 may have a specific set of preferences when he or visits Whole Foods in Boston, Mass. that are different from the set of preferences for Stop and Shop in Brookline, Mass., and the user 102 may have a specific set of preferences when he or she eats at Chili's in Texas versus at a Chili's in California. When the user 102 checks in at a certain location, the service provider server 180 is able to retrieve the user preferences for that merchant and for that location, and create a code that contains the relevant user preferences. The preferences may also depend on a time of day, day of the week, day/week of the month, etc. For example, a user may set a preference for a charity donation only on the 15^{th} and last day of each month to correspond with user pay days. Certain preferences may only apply once a month, such as donations, certain purchases (e.g., stamps), etc.

In some embodiments, the user 102 may set limits on which preferences he or she wishes to communicate to preserve his or her privacy. The limits can define what user preferences to share and what user preferences to withhold from a merchant, a merchant category, and/or a merchant location. For example, the user 102 may be hesitant to share contact information with a restaurant because he or she does not want to receive promotions or coupons in the mail. The user 102 can set limits on the user account so that his or her contact information is not shared with a particular restaurant, or with all restaurants in general. The user 102, however, may be comfortable sharing with the restaurant that he or she wants to donate to a charity or that he or she wants an electronic receipt.

In one embodiment, the user 102 also provides payment information to the service provider server 180. Payment information may include funding sources (e.g., bank account, credit card, etc.), rewards programs or cards, membership programs or rewards, points, discounts, offers, coupons, gift cards, or other merchant specific offers.

At step 204, when the user 102 is ready to pay, he or she checks in with a merchant using the mobile device 120 (or the service provider determines the location of the user 102 and the identity of the merchant), and the service provider server 180 receives a payment request.

At step 206, the service provider server 180 determines at least one user preference based on the payment request. For example, the service provider determines the user location and the merchant associated with the payment request. Once these are identified, the service provider server 180 can retrieve user preferences from account database 186 and determine what information and preferences the user 102 is willing to share with the merchant.

At step 208, the service provider server 180 generates a code that contains the at least one user preference. In one embodiment, a user authenticates his identity to a mobile application run by a service provider such as PayPal®, Inc. of San Jose, Calif., on a mobile device. The service provider identifies the user, identifies the merchant, generates the code, and transmits the code to the user's mobile device. In one embodiment, the use of the code allows the user 102 to apply loyalty rewards, offers, coupons, and store credit or gift cards to the transaction, without the use of a reward or membership card. Based on the user's privacy settings and preferences, the service provider server 180 creates a code that can be used by the user 102 at checkout.

In certain embodiments, the user 102 can control and set various limits on use of the code. For example, the user 102 can limit the price of items to be purchased using the code, the places that the code can be used, the times of day the code can be used, types of items to be purchased with the code, etc.

The code, in one embodiment, includes a random selection of letters, numbers, and/or other types of characters such as symbols (e.g., punctuation marks, emoticons, etc.), such as a numeric code, alphanumeric code, or letter code. In some embodiments, the code consists of two to sixteen characters, although different code lengths are also possible.

In other embodiments, the code includes a barcode, such as a Quick Response (QR) code. The barcode is a coded pattern of graphical indicia that includes of a series of stripes and spaces of varying widths, the stripes and spaces having differing light reflecting characteristics. Some of the more popular barcode symbologies include: Uniform Product Code (UPC); Data Matrix; Code 39; and Postnet. Barcodes may be one dimensional (1D), i.e., a single row of graphical indicia that carry information in one direction, such as a UPC bar code, or two dimensional (2D), i.e., multiple rows of graphical indicia that carry information in two directions, such as Data Matrix. Other examples of 2D barcodes include PDF417, MaxiCode, Aztec™ barcode, and the QR Code. A QR code is a matrix barcode, readable by QR scanners, mobile phones with a camera, and smartphones. The QR code consists of modules arranged in a square pattern on a white background. The information encoded can be text, a uniform resource locator (URL) or other data. Another embodiment of a code is a high frequency audio signal used in VeriFone terminals.

At step 210, the user 102 presents the code to the merchant, and the merchant receives the code. The code can be input by the user or a cashier at a point of sale (POS), or if the code is a barcode, the code can be scanned by the cashier. In some embodiments, upon receiving the code, the user preferences are displayed so that the cashier need not ask a lot of questions. The answers to the questions are contained or embedded in the code.

At step 212, the service provider receives the request for payment from the merchant, and approves and processes the payment. After processing, the service provider may then transmit a notification to the user and/or the merchant.

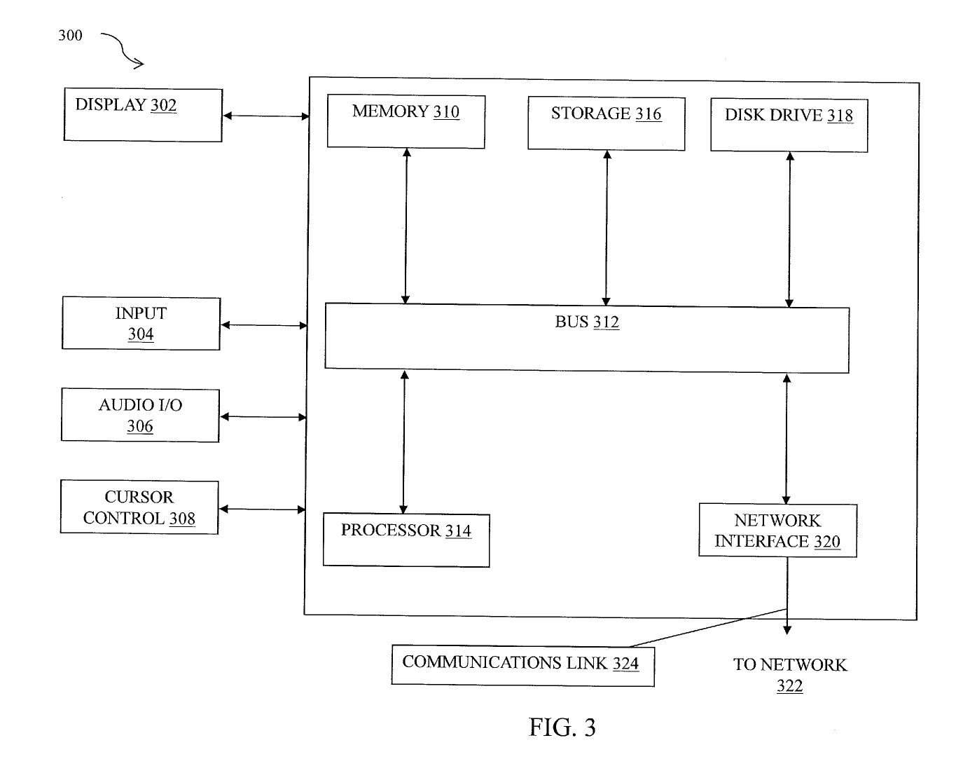

FIG. 3 is a block diagram of a computer system 300 suitable for implementing one or more embodiments of the present disclosure, including the mobile device 120, the merchant payee device 130, and the service provider server 180. In various implementations, the merchant payee device 130 may comprise a stand-alone computing device, such as an interactive computer terminal, the mobile device 120 may comprise a mobile cellular phone, personal computer (PC), laptop, PDA, etc. adapted for wireless communication, and the service provider server 180 may comprise a network computing device, such as a server. Thus, it should be appreciated that the devices 120, 130, and 180 may be implemented as computer system 300 in a manner as follows.

Computer system 300 includes a bus 312 or other communication mechanism for communicating information data, signals, and information between various components of computer system 300. Components include an input/output (I/O) component 304 that processes a user (i.e., sender, recipient, third party and/or payment provider) action, such as selecting keys from a keypad/keyboard, selecting one or more buttons or links, etc., and sends a corresponding signal to bus 312. I/O component 304 may also include an output component, such as a display 302 and a cursor control 308 (such as a keyboard, keypad, mouse, etc.). An optional audio input/output component 306 may also be included to allow a user to use voice for inputting information by converting audio signals. Audio I/O component 306 may allow the user to hear audio. A transceiver or network interface 320 transmits and receives signals between computer system 300 and other devices, such as another user device, a merchant server, or a payment provider server via network 328. In one embodiment, the transmission is wireless, although other transmission mediums and methods may also be suitable. A processor 314, which can be a micro-controller, digital signal processor (DSP), or other processing component, processes these various signals, such as for display on computer system 300 or transmission to other devices via a communication link 324. Processor 314 may also control transmission of information, such as cookies or IP addresses, to other devices.

Components of computer system 300 also include a system memory component 310 (e.g., RAM), a static storage component 316 (e.g., ROM), and/or a disk drive 318. Computer system 300 performs specific operations by processor 314 and other components by executing one or more sequences of instructions contained in system memory component 310. Logic may be encoded in a computer readable medium, which may refer to any medium that participates in providing instructions to processor 314 for execution. Such a medium may take many forms, including but not limited to, non-volatile media, volatile media, and transmission media. In various implementations, non-volatile media includes optical or magnetic disks, volatile media includes dynamic memory, such as system memory component 310, and transmission media includes coaxial cables, copper wire, and fiber optics, including wires that comprise bus 312. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by computer system 300. In various other embodiments of the present disclosure, a plurality of computer systems 300 coupled by communication link 324 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The various features and steps described herein may be implemented as systems comprising one or more memories storing various information described herein and one or more processors coupled to the one or more memories and a network, wherein the one or more processors are operable to perform steps as described herein, as non-transitory machine-readable medium comprising a plurality of machine-readable instructions which, when executed by one or more processors, are adapted to cause the one or more processors to perform a method comprising steps described herein, and methods performed by one or more devices, such as a hardware processor, user device, server, and other devices described herein.

What is claimed is:

1. A system, comprising:
a memory device storing user financial account information and user preferences; and
one or more processors in communication with the memory device and operable to:
receive a payment request at a merchant location;
determine at least one user preference based on the payment request; and
generate a code containing the at least one user preference for use by a merchant during checkout.

2. The system of claim 1, wherein the at least one user preference comprises packaging preferences, purchase preferences, personal information preferences, donation preferences, receipt preferences, or combinations thereof.

3. The system of claim 2, wherein the packaging preferences comprise a preference for plastic or paper shopping bags, the purchase preferences comprise a preference to purchase stamps or batteries, the personal information preferences comprise a preference to share an address or phone number, the donation preferences comprise a preference to donate to a specific charity, and the receipt preferences comprises a preference for an electronic receipt.

4. The system of claim 1, wherein the one or more processors is further operable to communicate the code to a user device.

5. The system of claim 4, wherein the one or more processors is further operable to communicate the code to the merchant.

6. The system of claim 1, wherein the one or more processors is further operable to match user preferences to a merchant data request based on user location or check-in.

7. The system of claim 1, wherein the code comprises a barcode, numeric code, alphanumeric code, letter code, or combinations thereof.

8. A method of facilitating payments at checkout, comprising:
receiving, by one or more hardware processors of a service provider, a payment request at a merchant location;
determining at least one user preference based on the payment request; and
generating a code containing the at least one user preference for use by a merchant during checkout.

9. The method of claim 8, wherein the at least one user preference comprises packaging preferences, purchase preferences, personal information preferences, donation preferences, receipt preferences, or combinations thereof.

10. The method of claim 9, wherein the packaging preferences comprise a preference for plastic or paper shopping bags, the purchase preferences comprise a preference to purchase stamps or batteries, the personal information preferences comprise a preference to share an address or phone number, the donation preferences comprise a preference to donate to a specific charity, and the receipt preferences comprises a preference for an electronic receipt.

11. The method of claim 8, further comprising communicating the code to a user device.

12. The method of claim 11, further comprising communicating the code to the merchant.

13. The method of claim 8, further comprising matching user preferences to a merchant data request based on user location or check-in.

14. The method of claim 8, wherein the code comprises a barcode, numeric code, alphanumeric code, letter code, or combinations thereof.

15. A non-transitory machine-readable medium comprising a plurality of machine-readable instructions which, when executed by one or more processors, are adapted to cause the one or more processors to perform a method comprising:
receiving a payment request at a merchant location;
determining at least one user preference based on the payment request; and
generating a code containing the at least one user preference for use by a merchant during checkout.

16. The non-transitory machine-readable medium of claim 15, wherein the at least one user preference comprises packaging preferences, purchase preferences, personal information preferences, donation preferences, receipt preferences, or combinations thereof.

17. The non-transitory machine-readable medium of claim 16, wherein the packaging preferences comprise a preference for plastic or paper shopping bags, the purchase preferences comprise a preference to purchase stamps or batteries, the personal information preferences comprise a preference to share address or phone number, the donation preferences comprise a preference to donate to a specific charity, and the receipt preferences comprises a preference for an electronic receipt.

18. The non-transitory machine-readable medium of claim 15, wherein the method further comprises communicating the code to a user device.

19. The non-transitory machine-readable medium of claim 18, wherein the method further comprises communicating the code to the merchant.

20. The non-transitory machine-readable medium of claim 15, wherein the method further comprises matching user preferences to a merchant data request based on user location or check-in.
